(19) United States
(12) Patent Application Publication
(10) Pub. No.: US 2025/0118085 A1
(43) Pub. Date: Apr. 10, 2025

(54) METHOD AND SYSTEM FOR DETECTION OF A VEHICLE THAT BLOCKS AN EMERGENCY VEHICLE

(71) Applicant: ELM, Riyadh (SA)

(72) Inventors: Athul M. MATHEW, Riyadh (SA); Riad SOUISSI, Riyadh (SA); Thariq KHALID, Riyadh (SA)

(73) Assignee: ELM, Riyadh (SA)

(21) Appl. No.: 18/901,516

(22) Filed: Sep. 30, 2024

Related U.S. Application Data
(60) Provisional application No. 63/588,140, filed on Oct. 5, 2023.

(51) Int. Cl. G06V 20/58; G06V 20/62

(52) U.S. Cl. CPC G06V 20/58; G06V 20/625

(57) ABSTRACT

A system for detection of a vehicle that blocks an ambulance while the ambulance is responding to an emergency call. The system includes a camera mounted on the ambulance that captures images or video of the surrounding area. A processor, such as an edge computing device with a graphical processing unit (GPU), analyzes the captured data to identify vehicles obstructing the ambulance's path. The system can identify both a leading violating vehicle that directly blocks the ambulance and a primary violating vehicle further ahead that may be causing the obstruction. The system also includes a communication unit to transmit data to a web-based portal or a cloud-based AI engine for further analysis and action.

### CROSS REFERENCE TO RELATED APPLICATION

The present application claims benefit of priority to U.S. Provisional Application No. 63/588,140 having a filing date of Oct. 5, 2023, which is incorporated herein by reference in its entirety.

### BACKGROUND

### Technical Field

The present disclosure is directed to traffic management systems, and specifically to an artificial intelligence-enabled system for detecting and managing vehicles that obstruct ambulances during emergencies.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

The increasing urbanization and vehicular traffic have led to challenges in ensuring the timely response of emergency vehicles, particularly ambulances. It is crucial for ambulances to navigate swiftly through traffic to reach those in need of urgent medical attention. However, the presence of vehicles blocking the path of an ambulance can significantly delay its arrival, potentially leading to adverse outcomes for patients. Most of the time, the vehicles in front of the ambulance make way for the ambulance; however, at times, vehicles don't change from the fast lane to the middle lanes, thus making it difficult for the ambulance to keep on the fast lane or the emergency lane. A major problem associated with the current state of the art is the lack of effective mechanisms to detect and identify vehicles that obstruct ambulances.

Conventional solutions for addressing this issue include public awareness campaigns to educate drivers about the importance of yielding to emergency vehicles. Some jurisdictions have also implemented laws and regulations that penalize drivers who fail to yield. Other solutions include the use of siren systems and public address systems to alert drivers of an approaching ambulance. Some systems also employ video recording devices to capture traffic violations, which are later reviewed and processed manually. GPS-based navigation tools are used to suggest less congested routes to ambulance drivers, attempting to circumvent areas prone to heavy traffic. However, existing systems lack the capability to automatically detect and identify violating vehicles in real-time, which may be utilized for taking immediate action to clear the path for the ambulance.

Accordingly, it is one object of the present disclosure to provide a system capable of identifying the specific vehicles responsible for the obstruction, providing accurate and timely information to relevant authorities. This information can then be used to enforce traffic regulations, penalize violators, and ultimately improve the efficiency of emergency response services. The present disclosure addresses this need by providing an automated system for detecting and identifying vehicles that block the path of an ambulance during emergency responses.

### SUMMARY

In an exemplary embodiment, a system for detection of a vehicle that blocks an ambulance while the ambulance is responding to an emergency call is described. The system includes a processor and a camera communicatively connected to the processor. The camera has a field of view that encompasses a surrounding of the ambulance. Herein, the processor is configured to identify a leading violating vehicle that blocks the ambulance.

In some embodiments, the processor is an edge computing device. The processor includes a graphical processing unit (GPU). The processor further includes a global positioning system (GPS) communicatively connected to the GPU. The processor further includes a communication unit communicatively connected to the GPU. The processor further includes a power management unit connected to the GPU. The processor further includes a supervisory unit communicatively connected to the GPU and the power management unit. The processor further includes a vehicle input unit communicatively connected to the supervisory unit. The vehicle input unit is configured to receive a plurality of input values from an operator.

In some embodiments, the edge computing device is configured to execute a program instruction. The program instruction comprises processing a video captured from the camera to obtain a plurality of video frames. The program instruction further comprises detecting a plurality of vehicles in the plurality of video frames. The program instruction further comprises assigning an identification number to each vehicle of the plurality of vehicles. The program instruction further comprises detecting and maintaining a vehicle trajectory of each vehicle of the plurality of vehicles. The program instruction further comprises determining a presence of the leading violating vehicle based on the vehicle trajectory. The program instruction further comprises identifying a license plate number of the leading violating vehicle. The program instruction further comprises storing the license plate number of the leading violating vehicle and the plurality of video frames in a database.

In some embodiments, the detecting the plurality of vehicles is performed with a deep neural network.

In some embodiments, the deep neural network is YOLO.

In some embodiments, the assigning is performed with a tracking neural network.

In some embodiments, the tracking neural network is Deep SORT.

In some embodiments, the determining the presence further comprises determining whether a first vehicle of the plurality of vehicles is blocking the ambulance for a predetermined duration based on the plurality of input values; and identifying the first vehicle as the leading violating vehicle.

In some embodiments, the edge computing device is further configured to identify a primary violating vehicle which causes the leading violating vehicles to fail to yield to the ambulance.

In some embodiments, the camera is disposed on a top of the ambulance. Herein, the camera is configured to capture an aerial view around the ambulance.

In some embodiments, the edge computing device is further configured to identify a primary violating vehicle which causes the leading violating vehicles to fail to yield to the ambulance.

In some embodiments, the communication unit of the edge computing device is configured to send a plurality of data to a web-based portal.

In some embodiments, the communication unit of the edge computing device is connected to a cloud system comprising an artificial intelligence engine. The artificial intelligence engine is configured to continuously detect the leading violating vehicle or the primary violating vehicle.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a schematic diagram of an architecture of a system for detection of a vehicle that blocks an ambulance while the ambulance is responding to an emergency call, according to certain embodiments.

FIG. 2 is an exemplary flowchart listing steps involved in a process of detection of the vehicle that blocks the ambulance, as implemented by the system, according to certain embodiments.

FIG. 3A is an exemplary depiction of a scenario showing an ambulance in a high-speed lane with various other vehicles around it, illustrating typical traffic conditions encountered by the ambulance while responding to an emergency call, according to certain embodiments.

FIG. 3B is an exemplary illustration of an interface implemented for detecting a violator vehicle in a field of view of a camera of the system, according to certain embodiments.

FIG. 3C is an exemplary illustration of an interface implemented for detecting a violator vehicle among multiple vehicles in a field of view of a camera of the system, according to certain embodiments.

FIG. 4 is an exemplary flowchart illustrating an operational process implemented by the system for identifying a leading violating vehicle that blocks an ambulance during an emergency call, according to certain embodiments.

FIG. 5 is a schematic diagram of a runtime process implemented by the system for detection of a vehicle that blocks an ambulance while the ambulance is responding to an emergency call, according to certain embodiments.

FIG. 6 is an illustration of a non-limiting example of details of computing hardware used in the computing system, according to certain embodiments.

FIG. 7 is an exemplary schematic diagram of a data processing system used within the computing system, according to certain embodiments.

FIG. 8 is an exemplary schematic diagram of a processor used with the computing system, according to certain embodiments.

FIG. 9 is an illustration of a non-limiting example of distributed components which may share processing with the controller, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of this disclosure are directed to a system for detecting and identifying vehicles that block the path of an ambulance during emergency responses. The system of the present disclosure addresses the issue of ambulance obstruction by employing advanced technologies to detect and identify vehicles blocking the path of an ambulance while the ambulance is responding to an emergency call. The system utilizes a camera to capture images or video of the surrounding area. The system also includes a processor, communicatively connected to the camera, to receive and analyze the captured data to identify vehicles that are obstructing path of the ambulance. This information can be used to alert the ambulance driver, transmit details of the obstructing vehicles to relevant authorities, or initiate other appropriate actions to ensure the clear path for the ambulance.

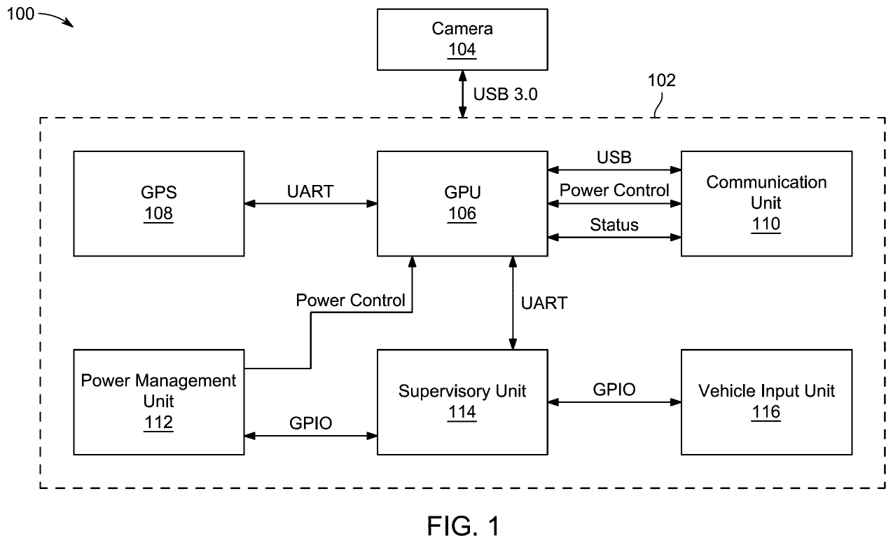

Referring to FIG. 1, illustrated is a schematic of an architecture of a system (as represented by reference numeral 100) for detection of a vehicle that blocks an ambulance while the ambulance is responding to an emergency call. The system 100 is capable of identifying a leading violating vehicle that blocks the ambulance. This system 100 is configured to identify and manage scenarios where vehicles blocks the path of an ambulance on route to an emergency, such as picking up or dropping a patient in need of urgent medical attention. Such blocking of ambulance by other vehicles, which is a common occurrence, can significantly delay medical response times. The system 100 of the present disclosure achieves this functionality through capture and analysis of visual data, to determine the presence of vehicles that may be blocking the ambulance. Once such vehicles are detected, the system 100 is also configured to process this information to determine the appropriate response required to mitigate the issue. In some embodiments, the system 100 send the information to a predetermined party, such as, local law enforcement authority, an agent, etc., to determine the appropriate response. Thereby, the system 100 helps in enhancing the efficiency of emergency medical services by ensuring that ambulances can reach their destinations with minimal delays caused by traffic obstructions.

As illustrated in FIG. 1, the system 100, primarily or broadly, includes a processor 102 and a camera 104. The camera 104 may be embodied as any suitable imaging device that has a field of view encompassing the surrounding of the ambulance. The camera 104 is communicatively connected to the processor 102. This allows the camera 104 to transmit the captured images or video to the processor 102 for analysis. The processor 102 is responsible for analyzing the data captured by the camera 104 and identifying obstructing vehicles. The camera 104 and processor 102 work in tandem to provide the required functionality to the system 100. The camera 104 continuously captures video data, transmitting it to the processor 102 in real-time. The processor 102, in turn, analyzes the incoming data, identifying potential obstacles and evaluating their impact on the ambulance's progress. This continuous cycle of data capture and analysis enables the system 100 to maintain a constant awareness of the surrounding traffic environment.

As used herein, the processor 102 is an embedded graphic processing unit (GPU) device which serves as the computational core of the system 100, responsible for analyzing the video data captured by the camera 104 and making real-time decisions regarding the presence of violating vehicles. Specifically, the processor 102 is configured to analyze the high-resolution visual data captured by camera 104, execute complex algorithms to detect and identify vehicles that are blocking the ambulance's path. The processor 102 can be any type of processor capable of performing the necessary computations, such as a general-purpose processor, a digital signal processor (DSP), or a specialized processor designed for image or video analysis, without any limitations. The processor 102 may be a single-core or multi-core processor, and may include various components such as a central processing unit (CPU), memory, and input/output interfaces. The specific type of processor 102 used in the system 100 can be tailored to the desired performance, power consumption, and cost constraints of the system 100.

Further, as used herein, the camera 104 serves as the visual input device, capturing real-time video footage of the ambulance's surroundings. The type of camera 104 utilized in the system 100 is selected based on its ability to meet the operational demands of the system 100, specifically its capacity to capture high-quality images or video. In general, the camera 104 is selected to capture images or video with sufficient resolution to discern the details of vehicles in the vicinity of the ambulance, including license plate numbers. In various embodiments, the resolution of the camera 104 is QCIF (176 pixels*120 pixels), CIF (352*240), 2CIF (704*240), 4CIF (704*480), D1 (720*480), 720p HD (1280*720), 960p HD (1280*960), 1.3 MP (1280*1024), 2 MP (1600*1200), 1080p HD (1920*1080), 3 MP (2048*1536), 4 MP (2688*1520), 5 MP (2592*1944), 6 MP (3072*2048), 8 MP/4K (Coax) (3840*2160), or 12 MP/4K (IP) (4000*3000). Additionally, the frame rate of the camera 104 is chosen to ensure smooth and continuous capture of the dynamic traffic scenario, allowing for accurate tracking of vehicle movements. In various embodiments, the frame rate of the camera 104 can be from 15 fps to 120 fps, preferably between 25 fps and 60 fps. In another embodiments, the frame rate of the camera 104 is about 25 fps. The camera 104 may also be equipped with features such as image stabilization, low-light enhancement, or wide dynamic range capabilities to ensure optimal image quality in various lighting and weather conditions.

As discussed, the camera 104 has a field of view that encompasses a surrounding of the ambulance, preferably a view facing the direction of travel of the ambulance and encompassing at least three lanes of traffic, such as a travel lane of the ambulance and at least one lane of traffic left of and at least one lane of traffic right of the travel lane. Preferably, the field of view is only forward of the placement of the camera. Specifically, In the present embodiments, the camera 104 is mounted on the dashboard or the windshield of the ambulance. In another embodiment, the camera 104 is disposed on a top of the ambulance. Such position provides an elevated vantage point for the camera 104, and that allows for a wider field of view compared to an only front-facing configuration or the like. Such placement enables the camera 104 to capture an aerial view around the ambulance. The captured aerial view may encompass the vehicles directly in front of the ambulance as well as those in adjacent lanes and potentially even further ahead. The aerial view provides a comprehensive understanding of the traffic situation, allowing the system 100 to identify potential obstacles and track vehicle movements with greater accuracy.

Further, in the present embodiments, the processor 102 is an edge computing device. In other words, the processor 102 in the system 100 is configured as an edge computing device. This means that the processor 102 performs its computational tasks directly at the source of data acquisition, which in this case, is the ambulance. By processing the video data directly on the ambulance, the system 100 can achieve real-time or near-real-time analysis, enabling faster identification of leading violating vehicles. This configuration reduces the need to transmit large amounts of video data to a remote server for processing, thereby minimizing latency and bandwidth requirements. This setup enhances the responsiveness of the system 100, allowing for quicker decision-making in dynamic traffic conditions.

In the present system 100, the processor 102 is configured to identify a leading violating vehicle that blocks the ambulance. A leading violating vehicle, as defined in the context of the present disclosure, is a vehicle that directly blocks the path of an ambulance, preventing it from proceeding in a timely manner. The processor 102 may employ a set of pre-determined criteria to identify such vehicles. These criteria may include the vehicle's proximity to the ambulance, its relative speed, and the duration for which it has been obstructing the ambulance's path. The processor 102 may continuously monitor the trajectories of all vehicles detected by the camera 104. The processor 102 may calculate the distance between each vehicle and the ambulance, assess their relative speeds, and track the duration for which any vehicle remains in a position that obstructs the ambulance. If a vehicle meets one or more of these criteria, the processor may identify such vehicle as a leading violating vehicle blocking the ambulance.

In various embodiments, the edge computing device (i.e., processor 102) is further configured to identify a primary violating vehicle which causes the leading violating vehicle to fail to yield to the ambulance. That is, the edge computing device within the system 100 is further configured to perform an advanced level of traffic analysis by identifying not just the leading violating vehicle but also a primary violating vehicle. The primary violating vehicle is defined as the vehicle that initiates a sequence of events causing subsequent vehicles, referred to as leading violating vehicles, to fail in yielding to the ambulance. This functionality is useful in scenarios where the traffic obstruction is not caused by a single vehicle but rather a cascade of reactions initiated by one key vehicle. This may be achieved through a more extensive analysis of the traffic scenario, considering the positions and trajectories of multiple vehicles in the vicinity of the ambulance. The system 100 may employ advanced algorithms that consider factors such as the relative speeds and distances between vehicles, lane changes, and overall traffic flow patterns. By identifying the primary violating vehicle, the system 100 can provide a more comprehensive understanding of the root cause of the obstruction, potentially leading to more effective enforcement measures and preventive strategies. In another embodiments, the system 100 may identify the primary violating vehicle based on images or video captured from the camera is disposed on a top of the ambulance and configured to capture an aerial view around the ambulance.

In present configuration, the processor 102, implemented as the edge computing device, may be equipped with specialized hardware to enhance the speed and efficiency of the video analysis process. As illustrated in FIG. 1, the processor 102 includes multiple interconnected components, including a graphical processing unit (GPU) 106, a global positioning system (GPS) 108, a communication unit 110, a power management unit 112, a supervisory unit 114, and a vehicle input unit 116. Each of these components and their interactions play a role in the functionality of the processor 102, to enable the operation of the system 100 for detection of the leading vehicle that may be blocking an ambulance while the ambulance is responding to an emergency call. It may be appreciated that the illustrated configuration is only exemplary, and the specific implementation may depend on the hardware and software choices made in the design of the system 100.

In the system 100, the GPU 106 serves as the primary computational engine within the processor 102. The GPU 106 is specifically configured to handle the intensive processing demands of video and image data that camera 104 captures. The GPU 106 is designed for performing complex mathematical computations with high speed and efficiency, as required for the real-time analysis of video footage to detect vehicles that may obstruct the ambulance. The speed and efficiency of GPU 106 ensure that data processing does not become a bottleneck, thereby facilitating fast response in the system 100. As shown, the GPU 106 is directly connected to the camera 104 through a communication interface, such as, for example, but not limited to, USB 3.0 interface, which supports high data transfer rates, ensuring that the video data is processed without significant delay.

The GPS 108 is incorporated to provide geolocation services to the system 100. The GPS 108 is responsible for acquiring satellite-based location data. The GPS 108 is communicatively connected to the GPU 106. In an example, the GPS 108 may be in communication with the GPU 106 via a serial port, such as a universal asynchronous receiver-transmitter (UART) interface or the like, without any limitations. The GPS 108 may communicate the acquired location information to the GPU 106. The integration of the GPS 108 allows the system 100 to track the precise location of the ambulance in real-time. This geolocation capability allows for navigating the ambulance efficiently as well as for mapping the positions of detected vehicles relative to the ambulance. Such spatial awareness enables accurately recording instances where vehicles block the ambulance's path and for potentially coordinating with traffic management systems to clear routes or guide the ambulance through congested areas.

The communication unit 110 of the processor 102 enables the system 100 to interface with external networks and systems. The communication unit 110 may utilize various communication technologies, such as cellular networks, Wi-Fi, or dedicated short-range communication protocols. In an example, the communication unit 110 may utilize a GSM 3G/4G module, which facilitates wireless communication capabilities. In present configuration, the communication unit 110 may act as a peripheral device to the GPU 106. A USB connection may be utilized for communication between the communication unit 110 and the GPU 106. The communication unit 110 may have dedicated connection for power control with the GPU 106 to allow for controlling its power state (like, turn the device on or off, or put it into low-power modes). Further, a status connection allows the communication unit 110 to report its operational status back to the GPU 106. Herein, the communication unit 110 may allow to transmit processed data, such as sending real-time alerts and video evidence of traffic obstructions to traffic management centers or emergency response teams. Additionally, the communication unit 110 enables remote monitoring and control of the system 100, allowing for updates to be made without the need for physical access to the hardware.

The power management unit 112 ensures that all components within the processor 102 receive the necessary power to operate efficiently without exceeding the energy capacity of a power unit of the system 100 (as available in the ambulance). The power management unit 112 is connected to the GPU 106 and other components via general-purpose input/output (GPIO) interfaces, which facilitate the control of power distribution based on the operational demands of the system 100. The power management unit 112 is responsible for managing power consumption, as required for maintaining stability of the system 100. For this purpose, the power management unit 112 may include various components such as voltage regulators, current limiters, and overvoltage protection circuits. In some examples, the power management unit 112 may also include a battery backup system to ensure that the system 100 can continue to operate even in the event of a power failure.

The supervisory unit 114 functions as the central control hub within the processor 102. The supervisory unit 114 is communicatively connected to the GPU 106 and the power management unit 112, through general-purpose input/output (GPIO) interfaces or the like. The supervisory unit 114 is responsible for the operations of all interconnected components. For instance, the supervisory unit 114 may manage the workflow between the GPU 106 and the power management unit 112, ensuring that the functions of data processing and the power management (for delivering required power for data processing) are synchronized. In general, the supervisory unit 114 monitors the operational status of the system 100, ensuring that each component is functioning correctly and coordinating their activities.

The vehicle input unit 116 provides an interface for the ambulance operator to interact with the system 100. In the present configuration, the vehicle input unit 116 is communicatively connected to the supervisory unit 114, for example, via GPIO interfaces. The vehicle input unit 116 is configured to receive a plurality of input values from an operator, for example, from dashboard controls or other input devices available to the ambulance driver or crew. For example, the operator may use the vehicle input unit 116 to adjust the sensitivity of the vehicle detection algorithm, view the live video feed from the camera 104, or review the recorded footage of any detected violations. By allowing the ambulance crew to configure and control the system 100 according to their specific needs and the conditions of their environment, the vehicle input unit 116 ensures that the system 100 remains adaptable and responsive to the real-time demands of emergency response scenarios.

Herein, in one configuration of the system 100, where the camera 104 is mounted on the windshield of the ambulance, the system 100 recognizes the movement of vehicles directly in front of the ambulance. For instance, if the vehicle immediately in front of the ambulance changes lanes to allow the ambulance to pass, but another vehicle in the next lane remains stationary, obstructing the path, the system 100 is designed to detect this scenario. Here, the AI system assesses the available space in the adjacent lane to confirm a violation by the second vehicle without necessitating a reset of the wait time counter that monitors vehicle obstruction duration.

Alternatively, in another configuration, where the camera 104 is positioned on top of the ambulance, providing an aerial view of the surrounding area (as discussed), the system 100 is capable of directly confirming a traffic violation by the obstructing vehicle, even if there is another vehicle between the ambulance and the violating vehicle. This is helpful in situations where the vehicle directly in front of the ambulance is unable to move aside due to another vehicle blocking its path in the adjacent lane. The configuration with the camera 104 mounted on top of the ambulance captures this interaction, obtaining a comprehensive 360-degree view of the roadway and vehicle occupancy in all lanes. This setup, thereby, enhances ability of the system 100 to monitor and respond to dynamic traffic conditions effectively.

In an embodiment, the communication unit 110 of the edge computing device (i.e., the processor 102), in the system 100, is configured to send a plurality of data to a web-based portal. This data may include information such as the license plate numbers of identified violating vehicles, corresponding video frames capturing the violation, location data from the GPS 108, timestamps of the violations, and any other relevant metadata. The transmission of this data to a web-based portal facilitates centralized storage, analysis, and management of the violation data, enabling efficient monitoring and enforcement of traffic regulations.

In another embodiment, the communication unit 110 of the edge computing device is connected to a cloud system comprising an artificial intelligence engine. This configuration enhances capacity of the system 100 to process and analyze traffic data on a more extensive scale. Herein, specifically, the artificial intelligence engine is configured to continuously detect the leading violating vehicle or the primary violating vehicle. That is, the artificial intelligence engine within the cloud system is specifically configured to perform continuous detection tasks which focus on identifying vehicles that significantly disrupt traffic flow and hinder the progress of emergency services, categorized either as leading violating vehicles or primary violating vehicles. The continuous detection capability provided by the artificial intelligence engine maintains up-to-date situational awareness and facilitates immediate responses to evolving traffic conditions. This allows for proactive traffic management measures, potentially clearing paths for ambulances and ensuring that emergency responses are not delayed.

Further, in an implementation of the present system 100, the processor 102 is positioned inside the ambulance and is directly linked to the ambulance's siren system. When the siren is activated during an emergency, it triggers the camera 104 connected to the processor 102 to start streaming video data. Simultaneously, an artificial intelligence (AI) model, which operates on the edge device of the processor 102, analyzes this streamed video to detect any violations related to traffic obstructions. When a violation is detected, metadata including the vehicle's image or video and GPS coordinates at the time of the violation are captured. This data is then transmitted directly to the Ambulance Authority's web portal using the communication unit 110 (such as, a 5G connection), ensuring that the information is relayed in real-time for immediate action.

In another implementation of the present system 100, a dashcam linked to the ambulance's siren system is utilized. When the siren is activated, the dashcam begins recording video, which is subsequently uploaded to object storage located in the cloud. Stored videos are accessed by an AI engine, which is set to continuously analyze the incoming video data for traffic violations. If a violation is detected, images of the violation along with the corresponding location coordinates are immediately sent to a predetermined party. In both configurations, an inspector agent reviews the detected violations to validate them and provides essential feedback to the system to enhance accuracy and reliability in future detections.

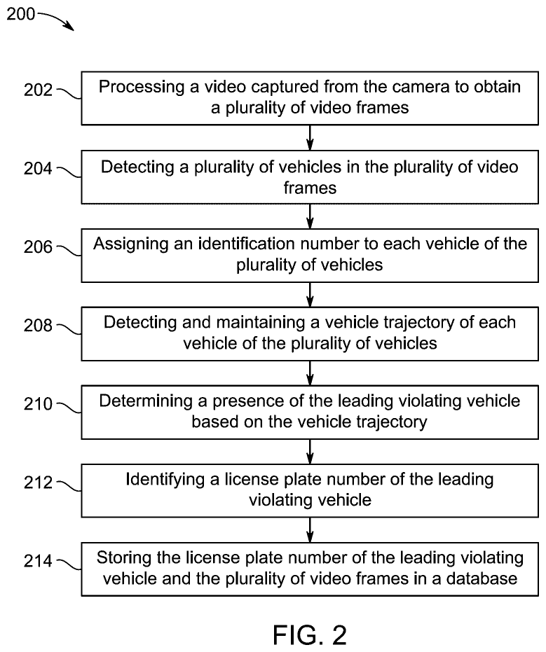

In the present system 100, the processor 102, implemented as the edge computing device within the system 100, is programmed to execute a program instruction (i.e., a specific instruction set) for the purpose of detection of a vehicle that blocks an ambulance while the ambulance is responding to an emergency call. FIG. 2 illustrates a flowchart listing steps involved in a process (as represented by reference numeral 200) of detection of the vehicle that blocks the ambulance, as implemented by the system 100. These steps are only illustrative, and other alternatives can also be provided where one or more steps are added, one or more steps are removed, or one or more steps are provided in a different sequence without departing from the scope of the claims herein.

At step 202, the process 200 includes processing a video captured from the camera 104 to obtain a plurality of video frames. This step involves the real-time extraction of continuous video footage into discrete frames, which can then be individually analyzed. This step transforms the dynamic visual information into a series of static images or frames that are easier to analyze and process. These frames are then processed to extract relevant information for the detection of violating vehicles.

At step 204, the process 200 includes detecting a plurality of vehicles in the plurality of video frames. That is, following the extraction of video frames, the next programmed instruction involves detecting the presence of various vehicles within these frames. This detection process involves analyzing each frame to identify objects that exhibit the characteristics of vehicles, such as their shape, size, and movement patterns. The edge computing device uses sophisticated algorithms, likely incorporating elements of machine learning and image recognition technologies, to identify and distinguish different vehicles captured in the video frames. This detection enables the system 100 to focus on relevant objects within the video data that may impact the ambulance's route.

In an embodiment, the detecting the plurality of vehicles is performed with a deep neural network. Deep neural networks are a class of machine learning algorithms that excel at pattern recognition and classification tasks, particularly in the realm of image and video analysis. The system 100 leverages the power of a deep neural network to accurately identify and locate vehicles within the video frames captured by the camera 104. In a specific embodiment, the deep neural network employed by the system 100 is YOLO (You Only Look Once). YOLO is a state-of-the-art object detection algorithm known for its speed and accuracy. It works by dividing the image into a grid and simultaneously predicting bounding boxes and class probabilities for each grid cell. The YOLO algorithm may be trained on a large dataset of annotated images, enabling it to learn the visual characteristics of vehicles and distinguish them from other objects in the scene. This approach allows YOLO to process images in near real-time, making it ideal for the fast-paced environment of emergency response. This, in turn, ensures that the system 100 can identify and respond to potential obstructions promptly, enhancing the overall efficiency and reliability of the emergency response service provided by the ambulance. In various embodiments, the deep neural network includes, but not limited to Faster R-CNN, CenterNet, DETR, or TridentNet.

At step 206, the process 200 includes assigning an identification number to each vehicle of the plurality of vehicles. That is, once vehicles are detected within the video frames, the edge computing device proceeds to assign a unique identification number to each vehicle. This assignment facilitates tracking and distinguishing each vehicle throughout the sequence of video frames. The identification numbers can be arbitrary or based on some characteristic of the vehicle, such as its license plate number or a unique identifier generated by the system 100. By assigning identification numbers, the system 100 establishes a framework for monitoring the behavior of each vehicle in relation to the ambulance.

In an embodiment, the assigning is performed with a tracking neural network. Such tracking neural network is designed to track objects over time, establishing and maintaining a unique identity for each object as it moves through the video frames. This capability allows for distinguishing between different vehicles and monitoring their individual behavior in relation to the ambulance. In a specific embodiment, the tracking neural network used for this purpose is Deep SORT (Simple Online and Realtime Tracking with a Deep Association Metric). Deep SORT is particularly suited for this task as it extends the basic SORT (Simple Online Realtime Tracking) algorithm by incorporating a deep learning-based feature extraction component. This enhancement allows Deep SORT to generate more accurate vehicle tracking, even in scenarios where the vehicles may be partially occluded or when the camera angles change. Thereby, the tracking neural network effectively matches vehicles across frames based on both their motion and appearance, assigning identification numbers with high reliability.

At step 208, the process 200 includes detecting and maintaining a vehicle trajectory of each vehicle of the plurality of vehicles. That is, after assigning identification numbers, the system 100 focuses on detecting and maintaining the trajectory of each identified vehicle. The trajectory represents the path that each vehicle follows over time, as observed in the sequence of video frames. In an implementation, a centroid position of each vehicle with a unique ID is accumulated over frames, thus enabling maintaining the vehicle trajectory for each unique ID. By maintaining a record of these trajectories, the edge computing device can analyze movement patterns and predict future positions of the vehicles. The system 100 continuously updates these trajectories as the vehicles move, creating a dynamic map of their positions relative to the ambulance. This information allows for determining whether a vehicle is obstructing the path of the ambulance and for how long it has been doing so.

At step 210, the process 200 includes determining a presence of the leading violating vehicle based on the vehicle trajectory. That is, following the tracking of vehicle trajectories, the edge computing device executes a program instruction to determine the presence of a leading violating vehicle. This involves analyzing the maintained vehicle trajectories to identify any vehicle that consistently blocks the path of the ambulance for an extended period. An AI module of the system 100 analyzes factors such as the distance between the ambulance and other vehicles, their relative speeds, and the duration for which a vehicle has been occupying a position that could obstruct the ambulance's path. By analyzing these parameters, the AI module of the system 100 can identify the vehicle that is most likely to be blocking the ambulance's path, thus designating it as the leading violating vehicle.

In an embodiment, the determining the presence further comprises determining whether a first vehicle of the plurality of vehicles is blocking the ambulance for a predetermined duration based on the plurality of input values. Herein, the system 100 focuses on the first vehicle, or the vehicle directly in front of the ambulance, as this vehicle has the most immediate potential to block the ambulance's path. The determination of whether the first vehicle is blocking the ambulance is based on the predetermined duration, which is a configurable parameter of the system 100. This duration is defined as the minimum amount of time that a vehicle must remain in a position obstructing the ambulance's path before it is considered a violation. The predetermined duration can be set by the operator using the vehicle input unit 116, allowing for flexibility and adaptability to different traffic conditions and regulations. It may be appreciated that this configurable input value should be an integer, and the input value represents seconds (in time). Specifically, to determine if the first vehicle has been blocking the ambulance for the predetermined duration, the system 100 analyzes the vehicle trajectory data. It calculates the time elapsed since the first vehicle was initially detected in a position that could potentially obstruct the ambulance. If this elapsed time exceeds the predetermined duration, the system 100 identifies the first vehicle as the leading violating vehicle. Further, the determining the presence comprises identifying the first vehicle as the leading violating vehicle. Once it is determined that the first vehicle has indeed been blocking the ambulance for longer than the predetermined duration, the system 100 then identifies this vehicle as the leading violating vehicle. In some embodiments, the system 100 send the information to a predetermined party, such as, local law enforcement authority, an agent, etc., to review the identification of the leading violating vehicle. This identification triggers a series of actions, such as alerting the ambulance driver, recording the license plate number of the violating vehicle, and transmitting violation data to relevant authorities (as discussed later in the description in more detail).

At step 212, the process 200 includes identifying a license plate number of the leading violating vehicle. That is, once a leading violating vehicle is identified, the next step executed by the edge computing device is to identify the license plate number of this vehicle. This process typically involves image processing techniques aimed at isolating and reading the license plate within the video frames where the vehicle has been detected. The system 100 may isolate the region of the video frame containing the license plate, enhance the image for better clarity, and then employ OCR to extract the alphanumeric characters that constitute the license plate number. The accurate identification of the license plate number helps in legal and administrative purposes, allowing authorities to trace the vehicle owner for accountability and possibly for issuing traffic violation notices.

At step 214, the process 200 includes storing the license plate number of the leading violating vehicle and the plurality of video frames in a database. That is, the final step in the sequence of program instructions executed by the edge computing device involves storing the license plate number of the leading violating vehicle, along with the plurality of video frames in which the vehicle was detected, in a database. Such storage preserves a record of the violation for future reference, facilitates review and analysis by traffic management or law enforcement agencies, and supports data integrity and evidence management for potential legal proceedings. The database is structured to ensure that the data is easily retrievable and linked to specific incidents, enhancing the efficiency of decision-making processes related to traffic management.

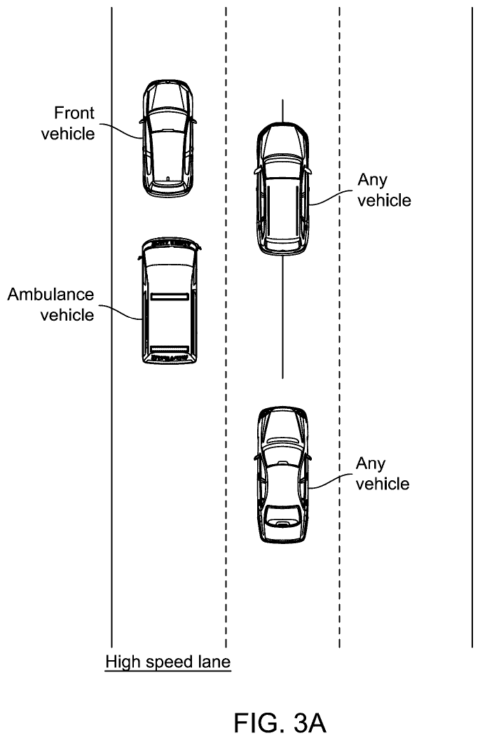

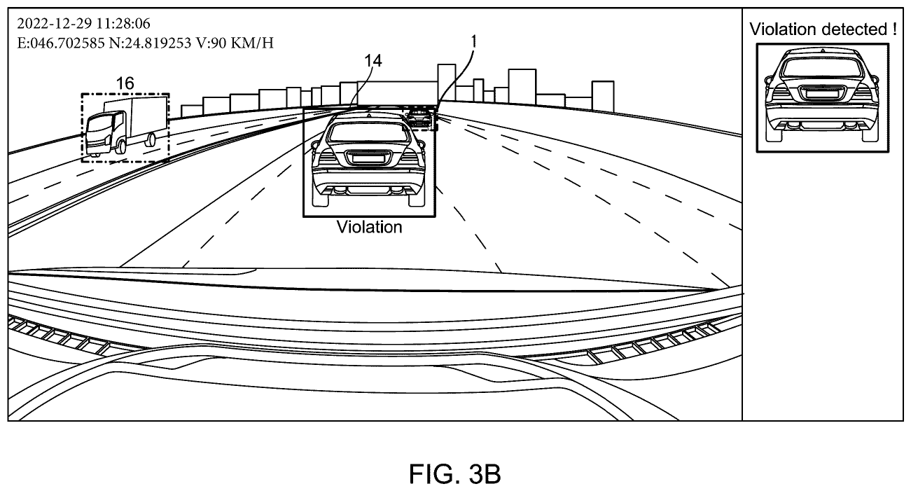

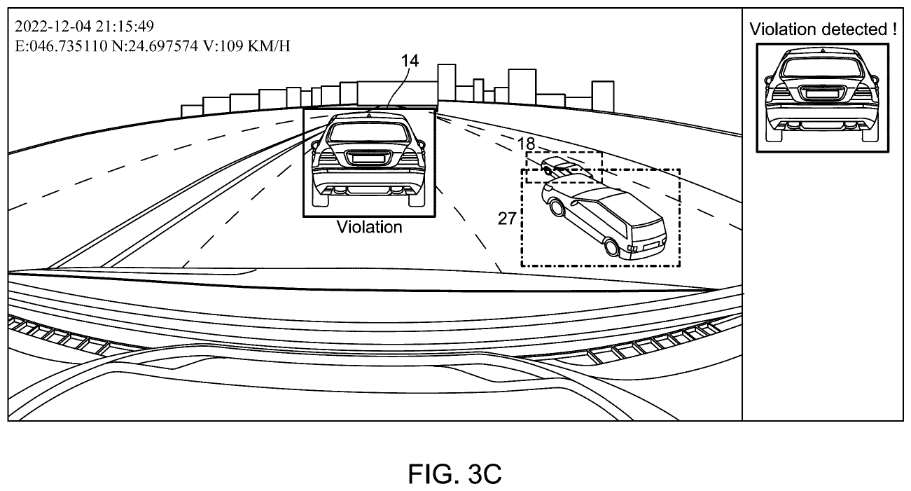

The detailed sequence of operations in the process 200 highlights the ability of the system 100 in managing and responding to traffic conditions that obstruct emergency medical services, thereby enhancing the effectiveness and safety of ambulance operations during critical situations. This systematic approach enables the system 100 to identify and address potential violations in real-time, thereby enhancing the effectiveness and safety of ambulance operations during critical situations. A practical implementation of the process 200 has further been discussed in reference to FIGS. 3A-3C, as described in the proceeding paragraphs.

FIG. 3A illustrates an exemplary depiction of a scenario showing an ambulance in a high-speed lane with various other vehicles around it. The depiction represents a typical traffic scenario, indicative of the types of data that the camera 104 mounted on the ambulance collects and transmits to the processor 102. The ambulance vehicle is shown positioned behind a front vehicle in the high-speed lane, with other vehicles labeled as “ANY VEHICLE” situated around it. These vehicles represent typical traffic conditions encountered by the ambulance while responding to an emergency call. Herein, the camera 104 captures continuous video footage of the roadway environment as the ambulance navigates through traffic. This video stream is then digitally processed by the GPU 106 within the processor 102, where the video stream is extracted into discrete frames. Each frame represents a still image of the traffic scene at a specific point in time, allowing the system 100 to analyze vehicle positions frame by frame. Upon obtaining these video frames, the system 100 identifies and categorizes each vehicle visible in the frames. In FIG. 3A, the vehicles are marked distinctly to demonstrate how they are recognized and tracked by the system 100. The identification process involves recognizing vehicle shapes, sizes, and distinguishing features that differentiate one vehicle from another in densely packed traffic conditions. This provides that all vehicles around the ambulance are accounted for, allowing for accurate monitoring and response to dynamic traffic situations.

FIG. 3B illustrates an exemplary interface implemented for detecting a violator vehicle in the field of view of the camera 104 of the system 100. In the illustrated example, the camera 104 in the system 100 has captured multiple vehicles on a high-speed lane, each designated with a unique identification number assigned by the tracking neural network (such as Deep SORT), utilized by system 100. For instance, three vehicles visible in this frame have been assigned identification numbers 1 (dashed line), 16, and 14 (solid line). These numbers allow for tracking each vehicle's movement across multiple frames, which aids in maintaining a consistent record of their trajectories and positions relative to the ambulance. The vehicle marked with unique ID 14 has been highlighted in the frame with an additional label indicating a “VIOLATION.” This designation signifies that the system 100 has detected this particular vehicle as violating traffic regulations that prioritize ambulance movement, specifically by obstructing the ambulance's path. The label “VIOLATION” is a result of the analysis where it has determined that vehicle ID 14 has blocked the ambulance for a predetermined duration, which goes against the traffic norms established for emergency situations.

FIG. 3C illustrates an exemplary interface implemented for detecting a violator vehicle among multiple vehicles in the field of view of the camera 104 of the system 100. In the illustrated example, the camera 104 in the system 100 has captured a multi-lane roadway scene where multiple vehicles are present. Each vehicle is identified and tracked by the system 100, which assigns unique identification numbers (IDs) to each one, as indicated by the numbers 14, 18, and 27 overlaid on the respective vehicles. These IDs allows for maintaining a continuous tracking record of each vehicle as they move within the field of view of the camera 104. Herein, the vehicle labeled with ID 14, which is directly in front of the ambulance, is marked with a “Violation” label, signifying that it has been identified by the system 100 as obstructing the ambulance's path. Furthermore, the system provides enhanced situational awareness by displaying a secondary vehicle, ID 18, which is highlighted in a dashed outline to the right. This vehicle is shown as a reference to illustrate the flow of traffic and to compare the behavior of different drivers under similar circumstances. In addition, as shown, the timestamp of the violation (2022-12-04 21:15:49), the GPS coordinates of the vehicle (E: 046.735110 N: 24.697574), and the vehicle's speed (109 KM/H). The ability of the system 100 to capture and present this detailed information in real-time demonstrates its effectiveness in monitoring traffic conditions and identifying violations.

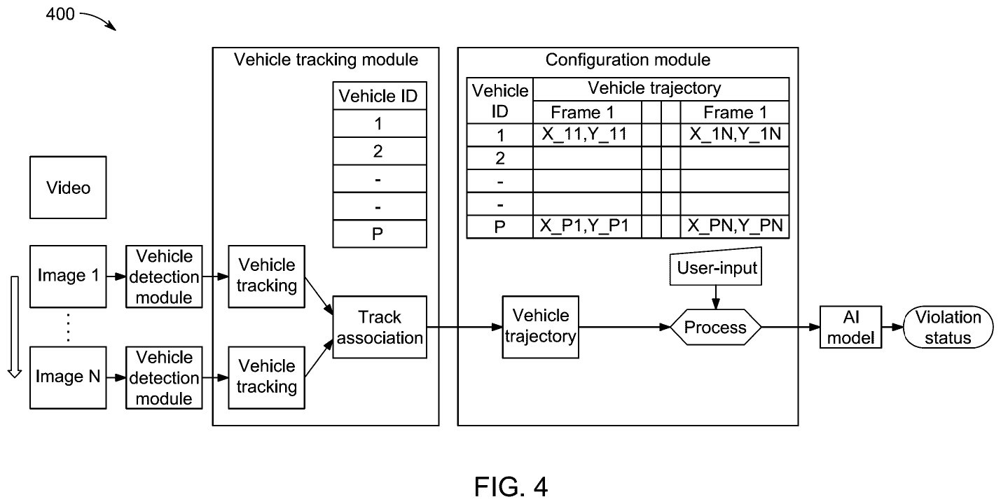

Referring now to FIG. 4, illustrated is an exemplary flowchart illustrating an operational process (as represented by reference numeral 400) implemented by the system 100 for identifying a leading violating vehicle that blocks an ambulance during an emergency call, according to certain embodiments. At the beginning of the process 400, the system 100 receives input in the form of video data, which comprises multiple frames (from Image 1 to Image N). These video frames are fed into the vehicle detection module. The vehicle detection module is configured for analyzing each frame to detect the presence of vehicles therein. Using advanced detection algorithms, based on deep learning frameworks for example, the vehicle detection module identifies various vehicles in the video data and prepares this information for further processing. Once vehicles are detected, the data moves to the vehicle tracking module, which engages two primary functions: vehicle tracking and track association. The vehicle tracking operation tracks the movement of each identified vehicle across the sequence of frames, maintaining a continuous record of their positions. Track association then links these movements over time to create a coherent track for each vehicle, effectively maintaining a trajectory.

These trajectories are fed into the configuration module, where each vehicle's trajectory is cataloged and associated with a specific vehicle ID. The configuration module organizes the data in a structured format, listing vehicle IDs alongside their corresponding positional coordinates in each frame (X_1, Y_1 through X_PN, Y_PN). The configuration module also integrates user inputs, which may include parameters like the duration a vehicle is obstructing the ambulance before it is flagged as a violation. These inputs are utilized for customizing response of the system 100 to specific operational scenarios. Subsequent to configuration, the processed data flows into an AI model, which analyzes the trajectories to determine if any vehicle meets the criteria for a traffic violation. The AI model uses complex algorithms to assess whether the movements and positions of the vehicles constitute a blockage to path of the ambulance. The outcome of analysis of the AI model is presented as a violation status. This violation status indicates whether a violation has been detected and identifies the violating vehicle. This information can be used to alert operators or directly initiate responses such as notifying traffic management authorities or dispatching alerts to relevant stakeholders. In the operational process 400, the AI model processes time-series based features to determine the presence of a violator vehicle. In this context, the time-series feature refers to the vehicle trajectory, which is supplied by the configuration module. In various embodiments, the AI model is based on the Random Forest algorithm, known for its accuracy and efficiency in handling classification tasks. However, the system 100 is also capable of integrating other machine learning algorithms such as XGBOOST or Support Vector Machines (SVM), depending on specific requirements or desired levels of prediction accuracy. These models are chosen for their ability to effectively handle large datasets and complex decision trees, making them suitable for dynamic and variable traffic conditions faced by emergency response systems.

Specifically, herein, the configuration module prepares and processes each vehicle's trajectory history, ensuring that the data is structured and ready for further analysis by the AI model. Once the vehicle trajectories are configured, they are passed to the AI model. The AI model is designed to handle data from multiple vehicles simultaneously. Depending on the number of vehicles detected and their unique IDs, the input to the AI model can be batched, allowing for efficient processing of data in groups. The AI model then evaluates this data to predict whether each vehicle has violated traffic rules. The outputs of analysis of the AI model are binary, classifying each vehicle's behavior as either ‘VIOLATION DETECTED’ or ‘VIOLATION NOT FOUND.’ This classification enables immediate decision-making regarding traffic management and emergency response.

In an example implementation of the configuration module within the operational process 400, the system 100 is set up to process video from the camera at a frame rate of 25 frames per second (‘fps’), and the AI module is configured to analyze vehicle trajectories with a length unit set at 50 (‘trajectoryunit’=50). The end-user of the system 100 has specified a duration of time for violation detection at 5 seconds (T=5 seconds), for setting the parameters for traffic violation detection based on the vehicle's trajectory over time, referred to as ‘vehicletrajectory’. Herein, the configuration module first calculates the span of vehicle trajectory history required for the AI to make a decision, termed as ‘trajectoryspan’. This is computed by multiplying the frame rate by the time duration set for detecting violations, calculated as fps multiplied by T. In this scenario, this calculation results in a trajectoryspan of 125 (25 fps×5 seconds). Next, the configuration module calculates a sampling factor ‘S’, which determines how the trajectory data should be sampled before being processed by the AI module. This sampling factor is derived by dividing the trajectoryspan by the trajectoryunit, resulting in S=2.5 (125/50). The configuration module then proceeds to sample the trajectory entries. For every index ‘ind’ within the list of the current vehicle trajectory, the configuration module samples the trajectory data based on the calculated sampling factor(S). This sampling is performed such that sampled trajectory ‘sampledtrajectory’ is obtained by selecting entries from vehicletrajectory at intervals defined by the integer value of the product of S and ind (sampledtrajectory=vehicletrajectory [int (S*ind)]). This sampledtrajectory is finally prepared and formatted to be fed as input into the AI module. This method ensures that the data provided to the AI is representative of the overall movement pattern of the vehicle over the designated time frame, thereby enabling accurate and efficient processing for violation detection.

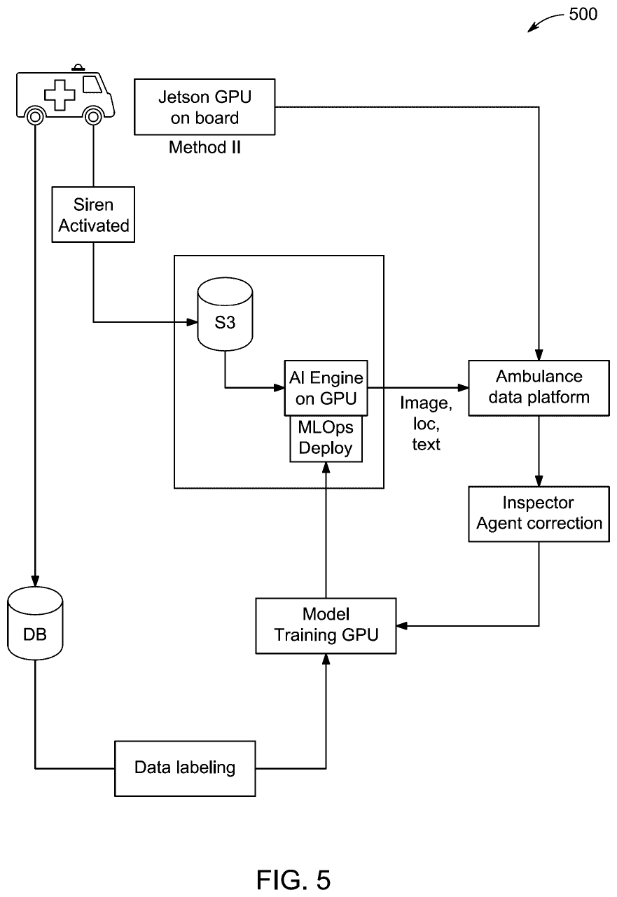

Referring to FIG. 5, illustrated is a schematic diagram of a runtime process (as represented by reference numeral 500) implemented by the system 100 for detection of a vehicle that blocks an ambulance while the ambulance is responding to an emergency call, according to certain embodiments. This diagram illustrates the interconnectedness of various components that facilitate operation of the system 100 from data acquisition to response implementation. The runtime process 500 begins with the siren activation on the ambulance, signaling the presence of an emergency situation. Once activated, the siren triggers a GPU (Jetson GPU) on board the ambulance under Method II, which is a part of initial response mechanism of the system 100. Following activation, the GPU interacts with an AI engine, which operates on the same GPU platform. The AI engine is responsible for the real-time analysis of data captured during the ambulance's journey. The engine utilizes MLOps (Machine Learning Operations) deployment strategies to ensure that the AI models running on the GPU are continuously updated based on the latest data and algorithms.

The data from the AI engine is then sent to a storage (S3 storage component), which acts as a temporary storage solution for the processed data. This includes video footage, location coordinates, and any detected text (such as license plates or street signs). From the storage, this data is forwarded to a more permanent database (DB), where it is stored for long-term access and retrieval. This database supports deeper analysis and record-keeping, contributing to data-driven decision-making processes. Simultaneously, the processed data is also sent to the ambulance data platform, which aggregates and displays the information in a format that is easily interpretable by human operators. This platform may show images, location data, and text in a user-friendly dashboard, enabling quick assessment and response by emergency response teams.

In addition to automated processing, there is an element of human oversight in the form of inspector agent correction. This component allows human inspectors or operators to review and potentially correct or verify outputs of the system 100, ensuring accuracy and reliability in the detection of traffic violations that could block the path of the ambulance. Furthermore, the system 100 incorporates a model training GPU, which is used for ongoing training and improvement of the AI models based on newly labeled data. Data labeling is a step where raw data is annotated with informative labels to train the AI models effectively. This iterative process ensures that the system 100 evolves and adapt to new situations or variations in traffic conditions, maintaining its efficacy over time.

The runtime process 500 (as presented in FIG. 5) allows the system 100 to quickly and accurately detect vehicles that block ambulances, and to take appropriate action to ensure the safety of emergency responders and the public. The described runtime process 500 ensures that all stakeholders, from traffic controllers to emergency medical teams, have access to accurate and timely information, facilitating coordinated efforts to manage emergency situations effectively.

The system 100 for detection of a vehicle that blocks an ambulance during an emergency call, as described herein, addresses the issue of ambulance obstruction. Unlike prior art solutions that rely on manual reporting or imprecise GPS tracking, the system 100 provides a real-time, automated solution for identifying violating vehicles. By leveraging advanced technologies such as deep neural networks and edge computing, the system 100 can accurately detect and track vehicles, determine their trajectories, and identify those that are blocking the path of the ambulance. This approach allows for timely intervention, potentially saving lives by reducing delays in emergency response.

The system 100 also offers several distinct advantages over prior art solutions. The system 100 is able to not only identify the leading violating vehicle as well as the primary violating vehicle that may be causing a chain reaction leading to the obstruction, but also provides a more comprehensive understanding of the traffic scenario. This enables targeted enforcement actions and can contribute to the development of more effective traffic management strategies. Additionally, the ability of the system 100 to capture and store detailed information about each violation, including license plate numbers, timestamps, and GPS coordinates, facilitates efficient documentation and potential legal action against offenders. The integration of the system 100 with cloud-based AI engines further enhances its capabilities, allowing for continuous monitoring and analysis of video data from multiple ambulances, thereby expanding the scope and effectiveness of the violation detection process.

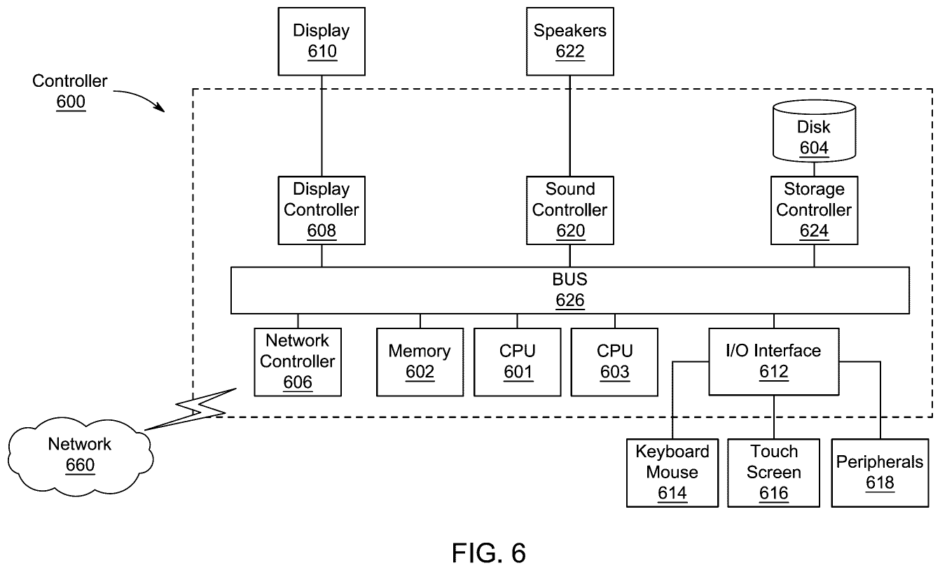

Next, further details of the hardware description of the computing environment according to exemplary embodiments is described with reference to FIG. 6. In FIG. 6, a controller 600 is described embodying the system 100 of the present disclosure, in which the controller is a computing device which includes a CPU 601 which performs the processes described above/below. The process data and instructions may be stored in memory 602. These processes and instructions may also be stored on a storage medium disk 604 such as a hard drive (HDD) or portable storage medium or may be stored remotely.

Further, the claims are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claims may be provided as a utility application, background daemon, or component of an operating system, or combination thereof, executing in conjunction with CPU 601, 603 and an operating system such as Microsoft Windows 7, Microsoft Windows 8, Microsoft Windows 10, UNIX, Solaris, LINUX, Apple MAC-OS and other systems known to those skilled in the art.

The hardware elements in order to achieve the computing device may be realized by various circuitry elements, known to those skilled in the art. For example, CPU 601 or CPU 603 may be a Xenon or Core processor from Intel of America or an Opteron processor from AMD of America, or may be other processor types that would be recognized by one of ordinary skill in the art. Alternatively, the CPU 601, 603 may be implemented on an FPGA, ASIC, PLD or using discrete logic circuits, as one of ordinary skill in the art would recognize. Further, CPU 601, 603 may be implemented as multiple processors cooperatively working in parallel to perform the instructions of the inventive processes described above.

The computing device in FIG. 6 also includes a network controller 606, such as an Intel Ethernet PRO network interface card from Intel Corporation of America, for interfacing with network 660. As can be appreciated, the network 660 can be a public network, such as the Internet, or a private network such as an LAN or WAN network, or any combination thereof and can also include PSTN or ISDN sub-networks. The network 660 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The computing device further includes a display controller 608, such as a NVIDIA GeForce GTX or Quadro graphics adaptor from NVIDIA Corporation of America for interfacing with display 610, such as a Hewlett Packard HPL2445w LCD monitor. A general purpose I/O interface 612 interfaces with a keyboard and/or mouse 614 as well as a touch screen panel 616 on or separate from display 610. General purpose I/O interface also connects to a variety of peripherals 618 including printers and scanners, such as an OfficeJet or DeskJet from Hewlett Packard.

A sound controller 620 is also provided in the computing device such as Sound Blaster X-Fi Titanium from Creative, to interface with speakers/microphone 622 thereby providing sounds and/or music.

The general purpose storage controller 624 connects the storage medium disk 604 with communication bus 626, which may be an ISA, EISA, VESA, PCI, or similar, for interconnecting all of the components of the computing device. A description of the general features and functionality of the display 610, keyboard and/or mouse 614, as well as the display controller 608, storage controller 624, network controller 606, sound controller 620, and general purpose I/O interface 612 is omitted herein for brevity as these features are known.

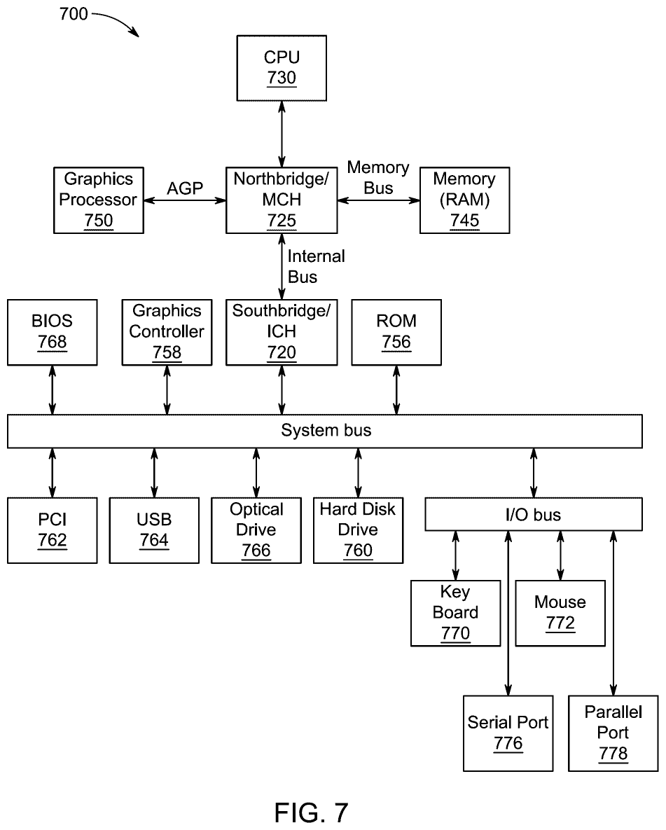

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 7.

FIG. 7 shows a schematic diagram of a data processing system, according to certain embodiments, for performing the functions of the exemplary embodiments. The data processing system is an example of a computer in which code or instructions implementing the processes of the illustrative embodiments may be located.

In FIG. 7, data processing system 700 employs a hub architecture including a north bridge and memory controller hub (NB/MCH) 725 and a south bridge and input/output (I/O) controller hub (SB/ICH) 720. The central processing unit (CPU) 730 is connected to NB/MCH 725. The NB/MCH 725 also connects to the memory 745 via a memory bus, and connects to the graphics processor 750 via an accelerated graphics port (AGP). The NB/MCH 725 also connects to the SB/ICH 720 via an internal bus (e.g., a unified media interface or a direct media interface). The CPU Processing unit 730 may contain one or more processors and even may be implemented using one or more heterogeneous processor systems.

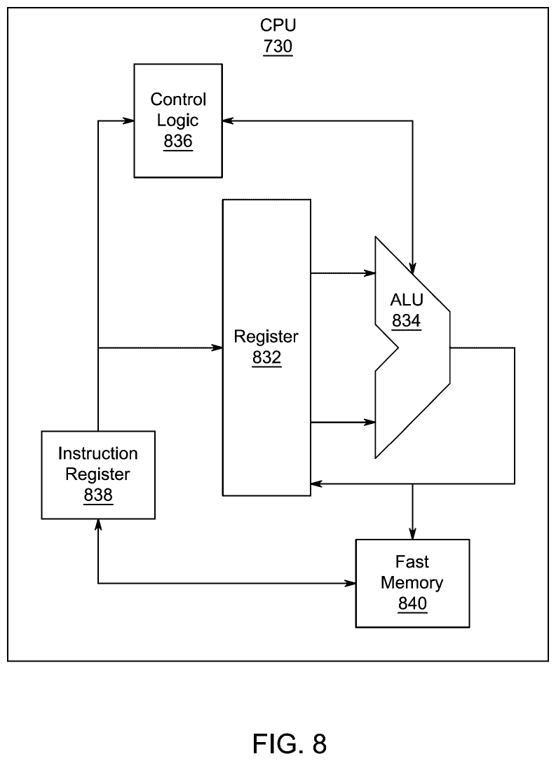

For example, FIG. 8 shows one implementation of CPU 730. In one implementation, the instruction register 838 retrieves instructions from the fast memory 840. At least part of these instructions are fetched from the instruction register 838 by the control logic 836 and interpreted according to the instruction set architecture of the CPU 730. Part of the instructions can also be directed to the register 832. In one implementation the instructions are decoded according to a hardwired method, and in another implementation the instructions are decoded according a microprogram that translates instructions into sets of CPU configuration signals that are applied sequentially over multiple clock pulses. After fetching and decoding the instructions, the instructions are executed using the arithmetic logic unit (ALU) 834 that loads values from the register 832 and performs logical and mathematical operations on the loaded values according to the instructions. The results from these operations can be feedback into the register and/or stored in the fast memory 840. According to certain implementations, the instruction set architecture of the CPU 730 can use a reduced instruction set architecture, a complex instruction set architecture, a vector processor architecture, a very large instruction word architecture. Furthermore, the CPU 730 can be based on the Von Neuman model or the Harvard model. The CPU 730 can be a digital signal processor, an FPGA, an ASIC, a PLA, a PLD, or a CPLD. Further, the CPU 730 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 7, the data processing system 700 can include that the SB/ICH 720 is coupled through a system bus to an I/O Bus, a read only memory (ROM) 756, universal serial bus (USB) port 764, a flash binary input/output system (BIOS) 768, and a graphics controller 758. PCI/PCIe devices can also be coupled to SB/ICH 788 through a PCI bus 762.

The PCI devices may include, for example, Ethernet adapters, add-in cards, and PC cards for notebook computers. The Hard disk drive 760 and CD-ROM 766 can use, for example, an integrated drive electronics (IDE) or serial advanced technology attachment (SATA) interface. In one implementation the I/O bus can include a super I/O (SIO) device.

Further, the hard disk drive (HDD) 760 and optical drive 766 can also be coupled to the SB/ICH 720 through a system bus. In one implementation, a keyboard 770, a mouse 772, a parallel port 778, and a serial port 776 can be connected to the system bus through the I/O bus. Other peripherals and devices that can be connected to the SB/ICH 720 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry or based on the requirements of the intended back-up load to be powered.

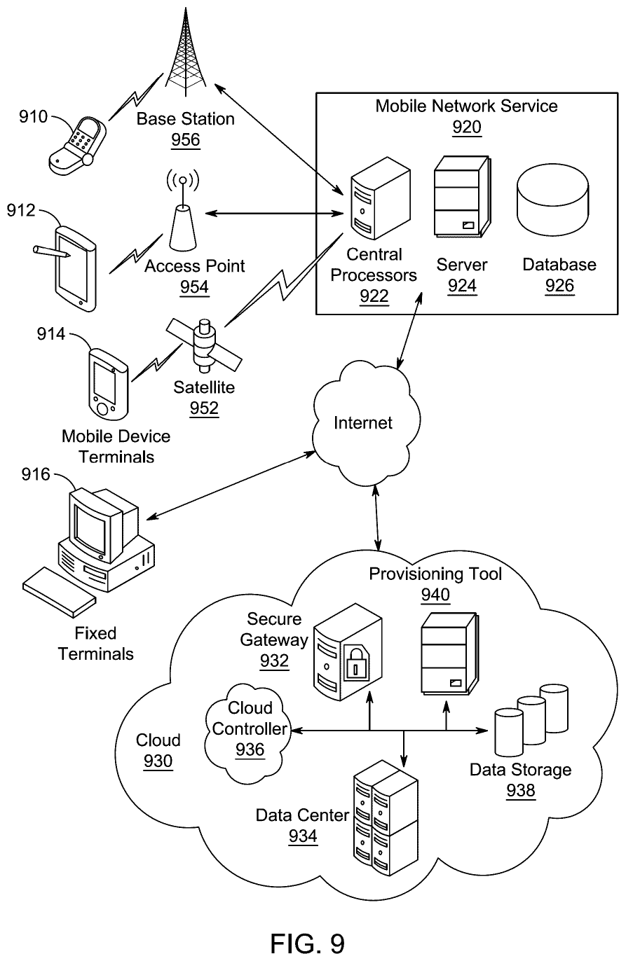

The functions and features described herein may also be executed by various distributed components of a system. For example, one or more processors may execute these system functions, wherein the processors are distributed across multiple components communicating in a network. The distributed components may include one or more client and server machines, such as cloud 930 including a cloud controller 936, a secure gateway 932, a data center 934, data storage 938 and a provisioning tool 940, and mobile network services 920 including central processors 922, a server 924 and a database 926, which may share processing, as shown by FIG. 9, in addition to various human interface and communication devices (e.g., display monitors 916, smart phones 910, tablets 912, personal digital assistants (PDAs) 914). The network may be a private network, such as a LAN, satellite 952 or WAN 954, or be a public network, may such as the Internet. Input to the system may be received via direct user input and received remotely either in real-time or as a batch process. Additionally, some implementations may be performed on modules or hardware not identical to those described. Accordingly, other implementations are within the scope that may be claimed.

The above-described hardware description is a non-limiting example of corresponding structure for performing the functionality described herein.

Numerous modifications and variations of the present disclosure are possible in light of the above teachings. It is therefore to be understood that within the scope of the appended claims, the invention may be practiced otherwise than as specifically described herein.

1. A system for detection of a vehicle that blocks an ambulance while the ambulance is responding to an emergency call, comprising:
a processor; and
a camera communicatively connected to the processor, wherein the camera has a field of view that encompasses a surrounding of the ambulance,
wherein the processor is configured to identify a leading violating vehicle that blocks the ambulance while the ambulance is responding to an emergency call.

2. The system of claim 1, wherein the processor is an edge computing device comprising:
a graphical processing unit (GPU);
a global positioning system (GPS) communicatively connected to the GPU;
a communication unit communicatively connected to the GPU;
a power management unit connected to the GPU;
a supervisory unit communicatively connected to the GPU and the power management unit; and
a vehicle input unit communicatively connected to the supervisory unit, wherein the vehicle input unit is configured to receive a plurality of input values from an operator.

3. The system of claim 2, wherein the edge computing device is configured to execute a program instruction comprising:
processing a video captured from the camera to obtain a plurality of video frames;
detecting a plurality of vehicles in the plurality of video frames;
assigning an identification number to each vehicle of the plurality of vehicles;
detecting and maintaining a vehicle trajectory of each vehicle of the plurality of vehicles;
determining a presence of the leading violating vehicle based on the vehicle trajectory of each vehicle of the plurality of vehicles;
identifying a license plate number of the leading violating vehicle; and
storing the license plate number of the leading violating vehicle and the plurality of video frames in a database.

4. The system of claim 3, wherein the detecting the plurality of vehicles is performed with a deep neural network.

5. The system of claim 4, wherein the deep neural network is YOLO.

6. The system of claim 3, wherein the assigning is performed with a tracking neural network.

7. The system of claim 6, wherein the tracking neural network is Deep SORT.

8. The system of claim 3, the determining the presence of the leading violating vehicle further comprises:
determining whether a first vehicle of the plurality of vehicles is blocking the ambulance for a predetermined duration based on the plurality of input values; and
identifying the first vehicle as the leading violating vehicle.

9. The system of claim 3, wherein the edge computing device is further configured to identify a primary violating vehicle which causes the leading violating vehicle to fail to yield to the ambulance.

10. The system of claim 3, wherein the camera is disposed on a top of the ambulance, wherein the camera is configured to capture an aerial view around the ambulance.

11. The system of claim 10, wherein the edge computing device is further configured to identify a primary violating vehicle which causes the leading violating vehicles to fail to yield to the ambulance.

12. The system of claim 3, wherein the communication unit of the edge computing device is connected to a cloud system comprising an artificial intelligence engine, wherein the artificial intelligence engine is configured to continuously detect the leading violating vehicle or the primary violating vehicle.

13. The system of claim 12, wherein the Artificial intelligence engine is based on a Random Forest.

14. A method of detecting a leading violating vehicle that blocks an ambulance while the ambulance is responding to an emergency call, comprising:
processing a video captured from a plurality of cameras to obtain a plurality of video frames, wherein the plurality of cameras is mounted on the ambulance and configured to capture the video of a surrounding of the ambulance;
detecting a plurality of vehicles in the plurality of video frames;
assigning an identification number to each vehicle of the plurality of vehicles;
detecting and maintaining a vehicle trajectory of each vehicle of the plurality of vehicles;
determining a presence of the leading violating vehicle based on the vehicle trajectory;
identifying a license plate number of the leading violating vehicle; and
storing the license plate number of the leading violating vehicle and the plurality of video frames in a database.

15. The method of claim 14, wherein the detecting the plurality of vehicles is performed with a deep neural network and wherein the assigning is performed with a tracking neural network.

16. The method of claim 15, wherein the deep neural network is YOLO and wherein the tracking neural network is Deep SORT.

17. The method of claim 14, the determining the presence further comprises:
determining whether a first vehicle of the plurality of vehicles is blocking the ambulance for a predetermined duration based on the plurality of input values; and
identifying the first vehicle as the leading violating vehicle.

18. The method of claim 17, wherein the edge computing device is further configured to identify a primary violating vehicle which causes the leading violating vehicles to fail to yield to the ambulance.

19. The method of claim 14, wherein the camera is disposed on a top of the ambulance, wherein the camera is configured to capture an aerial view around the ambulance.

20. The method of claim 19, wherein the edge computing device is connected to a cloud system comprising an artificial intelligence engine based on a Random Forest, and wherein the artificial intelligence engine based on the Random Forest is configured to continuously detect the leading violating vehicle or the primary violating vehicle.
